(19) United States
(12) Patent Application Publication
(10) Pub. No.: US 2014/0071508 A1
(43) Pub. Date: Mar. 13, 2014

(54) OPTICAL DEVICE, OPTICAL SCANNING DEVICE, AND IMAGE FORMING APPARATUS

(71) Applicants: Hiroyuki YAMADA, Kanagawa (JP); Susumu Mikajiri, Tokyo (JP)

(72) Inventors: Hiroyuki YAMADA, Kanagawa (JP); Susumu Mikajiri, Tokyo (JP)

(21) Appl. No.: 13/975,646

(22) Filed: Aug. 26, 2013

(30) Foreign Application Priority Data
Sep. 7, 2012 (JP) 2012-197760
Mar. 29, 2013 (JP) 2013-073110
Jul. 9, 2013 (JP) 2013-143579

(51) Int. Cl. G02B 26/10; G02B 7/182

(52) U.S. Cl. CPC G02B 26/10; G02B 7/182
USPC 359/205.1; 359/871

(57) ABSTRACT

An optical device includes a long mirror; a mirror pressing member configured to fix the long mirror; a mirror-reflective-surface receiving member configured to be in contact with a reflective surface of the long mirror; and at least two mirror receiving members configured to be in contact with a face other than the reflective surface of the long mirror in a mirror longitudinal direction so that a distance between the mirror receiving members in the mirror longitudinal direction is variable.

### CROSS-REFERENCE TO RELATED APPLICATIONS

The present application claims priority to and incorporates by reference the entire contents of Japanese Patent Application No. 2012-197760 filed in Japan on Sep. 7, 2012, Japanese Patent Application No. 2013-073110 filed in Japan on Mar. 29, 2013 and Japanese Patent Application No. 2013-143579 filed in Japan on Jul. 9, 2013.

### BACKGROUND OF THE INVENTION

1. Field of the Invention

The present invention relates to an optical device with a reflecting mirror as a long mirror, an optical scanning device, and an image forming apparatus.

2. Description of the Related Art

An optical scanning device used in an electrophotographic image forming apparatus employs an optical device that includes a reflecting mirror as a long mirror used to direct a light beam emitted from a light source to an image carrier. The optical scanning device, however, is installed in the body of the image forming apparatus, and therefore the reflecting mirror is shaken by vibration of a drive system of the image forming apparatus body. Consequently, the optical scanning device has a problem of uneven image density, so-called banding, due to displacement of an image location of the light beam on the image carrier. Therefore, a technology has been known in which a drive frequency of the image forming apparatus body and a resonance point of the reflecting mirror are displaced from each other and the vibration of the reflecting mirror is suppressed by attaching a vibration damping material to the reflecting mirror or by pressing the reflecting mirror with a plate spring. In addition, Japanese Laid-open Patent Publication No. 11-142767 discloses a countermeasure against vibration of a reflecting mirror by increasing the strength and the volume of the reflecting mirror by bonding a mirror reinforcing member to the reflecting mirror for the purpose of suppressing the vibration of the reflecting mirror and preventing the banding.

In the conventional countermeasures against the vibration by attaching the vibration damping material to the reflecting mirror or pressing the reflecting mirror with the plate spring, it is required to change a natural frequency of the reflecting mirror according to a device or a model because a drive frequency of the drive system of the image forming apparatus body changes depending on the device or the model. Therefore, the shape of the vibration damping material or the pressing force of the plate spring has to be changed, which makes it difficult to change the natural frequency of the mirror appropriately. In addition, troublesome attachment of the vibration damping material to the reflecting mirror and an increase in the number of components of the vibration damping material or of the plate spring cause a cost increase.

In Japanese Laid-open Patent Publication No. 142767, the vibration of the reflecting mirror can be suppressed, but the natural frequency of the mirror cannot be changed appropriately according to a drive frequency of the drive system of the image forming apparatus body. In addition, because the mirror reinforcing material is bonded to the reflecting mirror, the troublesome task and the increase in the number of components lead to the cost increase.

Therefore, there is a need to provide an optical device capable of easily changing a natural frequency and a vibration mode and having a low-cost new vibration damping structure without requiring troublesome task, an optical scanning device, and an image forming apparatus.

### SUMMARY OF THE INVENTION

It is an object of the present invention to at least partially solve the problems in the conventional technology.

According to an embodiment, an optical device that includes a long mirror; a mirror pressing member configured to fix the long mirror; a mirror-reflective-surface receiving member configured to be in contact with a reflective surface of the long mirror; and at least two mirror receiving members configured to be in contact with a face other than the reflective surface of the long mirror in a mirror longitudinal direction so that a distance between the mirror receiving members in the mirror longitudinal direction is variable.

According to another embodiment, an optical device that includes a long mirror; a mirror pressing member configured to fix the long mirror; a mirror-reflective-surface opposite-face receiving member configured to be in contact with an opposite face to a reflective surface of the long mirror; and at least two mirror receiving members configured to be in contact with a face other than the reflective surface of the long mirror in a mirror longitudinal direction so that a distance between the mirror receiving members in the mirror longitudinal direction is variable.

According to still another embodiment, an optical scanning device that includes the optical device according to any one of the above embodiments; a light source; an imaging optical element configured to condensing light emitted from the light source; a rotary deflector configured to rotationally change the light emitted from the light source; and a scanning optical element configured to scan the deflected light. The long mirror of the optical device is configured to guide the scanned light to an image carrier.

According to still another embodiment, an image forming apparatus that includes the optical scanning device according to the above embodiment.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an optical scanning device provided with an optical device according to the present invention;

FIG. 2A is an enlarged view of a fixing structure of a long mirror as a main portion of the present invention, in which a reflective surface of the long mirror is received by a mirror-reflective-surface receiving member;

FIG. 2B is an enlarged view of a fixing structure of the long mirror as the main portion of an embodiment, in which an opposite face to the reflective surface of the long mirror is received by a mirror-reflective-surface opposite-face receiving member;

FIG. 3 is a perspective view of the fixing structure of the long mirror as the main portion of another embodiment;

FIGS. 4A and 4B are enlarged views of structures of how to receive an end face of the long mirror in the embodiments, respectively;

FIGS. 5A and 5B are enlarged views of structures in which an end-face receiving position of the long mirror is changed in the embodiments, respectively;

FIG. 6 is a diagram of a layout of mirror receiving members;

FIG. 7 is a diagram of characteristics of a vibration frequency and a vibration mode of the long mirror depending on the end-face receiving position;

FIG. 8 is a diagram of an image forming apparatus according to the embodiment;

FIG. 9 is an enlarged perspective view of a structure of a mirror receiving member having a base and of a moving form of the mirror receiving member;

FIG. 10 is a perspective view of a structure of the mirror receiving member provided with fixing holes on the base;

FIG. 11 is a perspective view of a structure of fixing screw holes for the mirror receiving member provided in an optical housing;

FIG. 12 is a side view of how the mirror receiving member with the base is fixed by a fastener member; and

FIG. 13 is a side view of how the mirror receiving member with the base is fixed by adhesion.

### DETAILED DESCRIPTION OF THE PREFERRED EMBODIMENTS

Embodiments of the present invention has characteristics as follows when vibration of the reflecting mirror as the long mirror provided in the optical device is to be suppressed. In other words, the embodiments are characterized in that when the reflecting mirror is held, the mirror receiving member for receiving the reflective surface of the reflecting mirror or a face other than the opposite face to the reflective surface of the long mirror in the mirror longitudinal direction is provided in at least two locations in the mirror longitudinal direction, a distance between the mirror receiving members can be changed, and the distance between the mirror receiving members is changed to thereby change the mirror vibration frequency and the vibration mode of the reflecting mirror.

Exemplary embodiments of the present invention will be explained below with reference to the accompanying drawings.

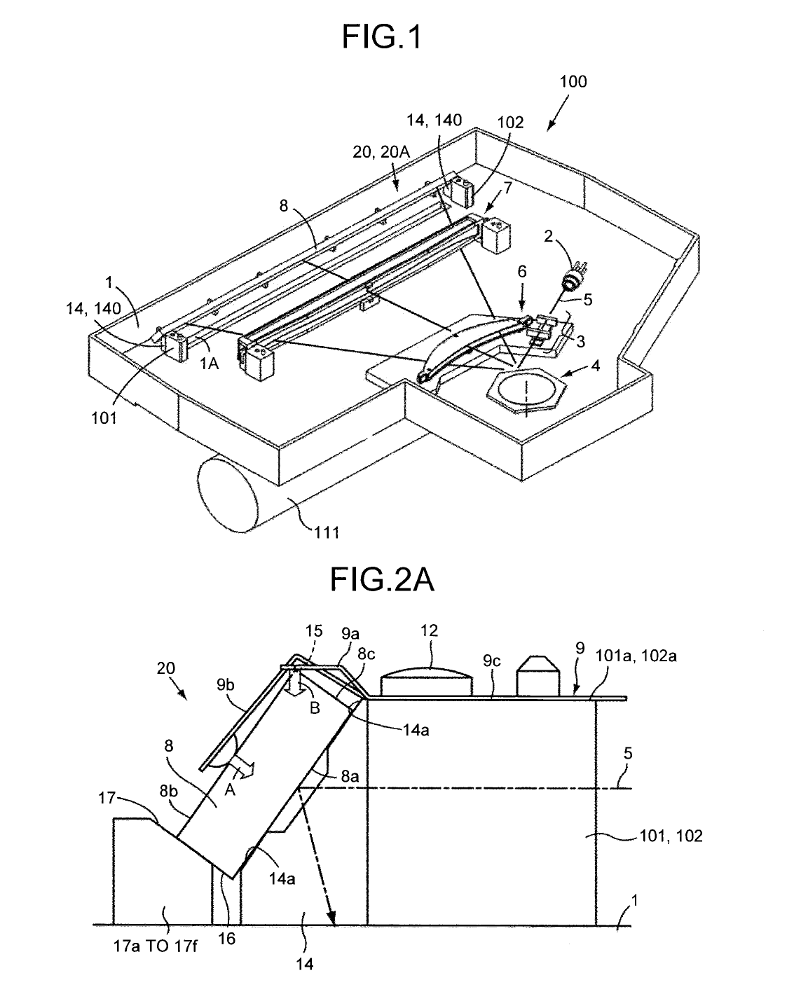

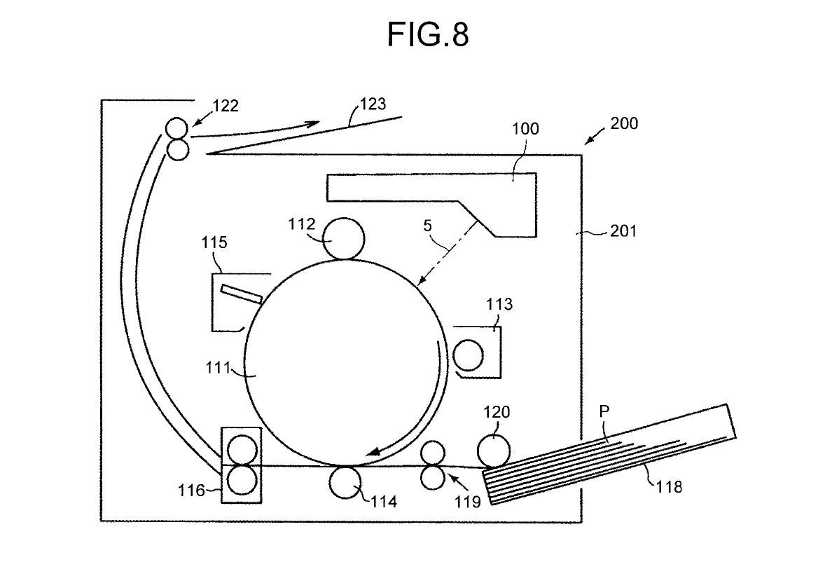

FIG. 1 depicts a configuration of an optical scanning device 100 according to an embodiment of the present invention. The optical scanning device 100 has an optical housing 1 being a box-shaped housing. Components that constitute the optical scanning device 100 are stored in the optical housing 1, and the optical housing 1 is attached to an apparatus body 201 of an image forming apparatus 200 shown in FIG. 8. A housing cover (not shown) for blocking the optical housing 1 from the outside and for covering an opening is provided over the optical housing 1 for the purpose of dust proofing, sound proofing, and light shielding, and the housing cover is closed after the components are assembled.

Arranged inside the optical housing 1 are a light source 2 that emits a light beam 5, a condenser lens (cylindrical lens) 3 serving as an imaging optical element for condensing the light beam 5 emitted from the light source 2, and a polygon motor 4 serving as a rotating polygon mirror for rotationally deflecting the condensed light beam 5. The light beam 5 emitted from the light source 2 and condensed by the condenser lens 3 is deflected by the polygon motor 4 rotating around its axis.

Arranged inside the optical housing 1 are also a plurality of scanning optical lenses 6 and 7 for scanning the deflected light beam 5 and a plate-like reflecting mirror 8 as a long mirror for guiding the scanned light beam 5 to a photoreceptor 111 as an image carrier. An opening 1A is formed in the optical housing 1 in a traveling direction of the light beam 5 reflected by the reflecting mirror 8. A dustproof glass (not shown) is provided in the optical housing 1 so as to cover the opening 1A, and the dustproof glass is held by a dustproof-glass holding member (not shown) for holding the dustproof glass.

Therefore, the deflected light beam 5 is scanned by the scanning optical lenses 6 and 7, is reflected by the reflecting mirror 8, and is guided from the opening 1A formed in the optical housing 1 to the photoreceptor 111 being the image carrier.

In the present embodiment, the scanning optical system is formed with the lens system; however, it may be formed with reflective optics, or may be formed in combination of the lens system and the reflective optics.

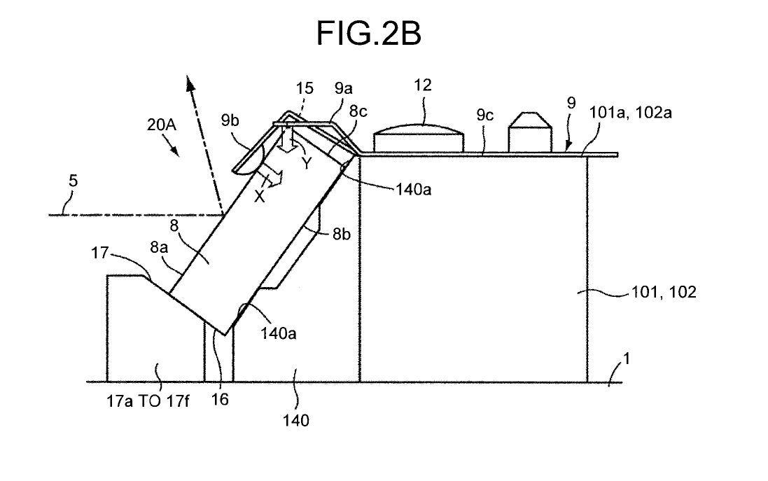

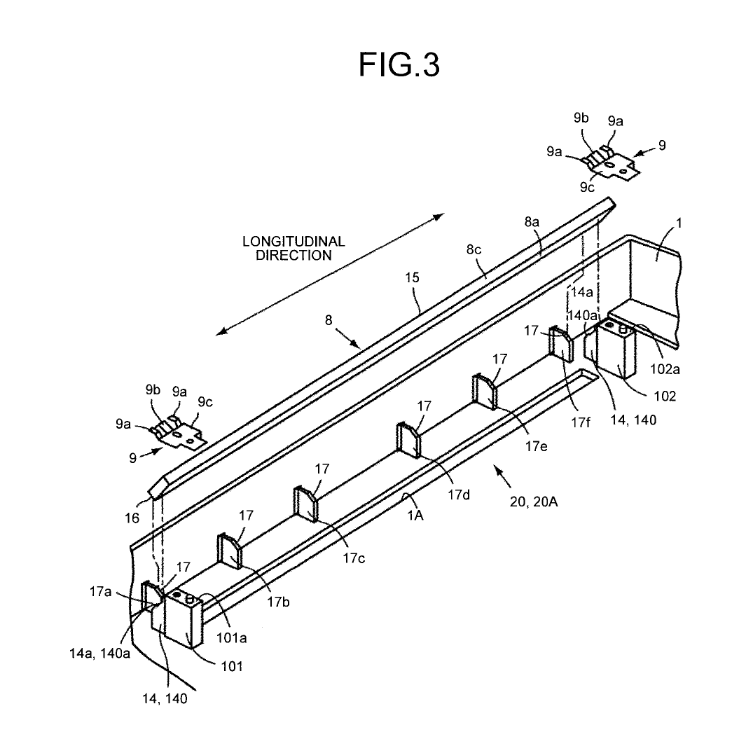

FIG. 2A and FIG. 3 are enlarged views of an embodiment of a fixing structure of the reflecting mirror 8 as the main portion. The optical housing 1 includes a plurality of mirror pressing members 9 for fixing the reflecting mirror 8 to the optical housing 1, mirror-reflective-surface receiving members 14 that come in contact with a reflective surface 8a side of the reflecting mirror 8 to receive and support the reflective surface, and mirror receiving members 17a to 17f that come in contact with a mirror bottom end face 16 being a face other than the reflective surface 8a of the reflecting mirror 8 in the longitudinal direction to receive and support the face. The reflecting mirror 8, the mirror pressing members 9, the mirror-reflective-surface receiving members 14, and the mirror receiving members 17a to 17f constitute an optical device 20. The mirror receiving members 17a to 17f are provided at intervals in the longitudinal direction of the reflecting mirror 8, and function as the mirror receiving members that support the mirror bottom end face 16 and as auxiliary mirror receiving members that become an avoidance state without coming in contact with the mirror bottom end face 16.

As shown in FIG. 2A and FIG. 3, the mirror pressing members 9 are formed with a resin material or a plate spring material. Each of the mirror pressing members 9 includes a base end 9c, arm portions 9a for pushing a mirror edge line 15 being an upper corner of the reflecting mirror 8 downward in the figure indicated by arrow B, and an arm portion 9b for pushing an opposite face 8b to the reflective surface 8a of the reflecting mirror 8 in a direction of the mirror-reflective-surface receiving members 14 indicated by arrow A. The arm portions 9a and the arm portion 9b are configured so as to be elastically deformable. The reflecting mirror 8 is pushed against the direction of arrow A by the arm portion 9b of the mirror pressing member 9 to be pressed against inclined surfaces 14a of the mirror-reflective-surface receiving members 14 which are formed in the optical housing 1 along the pushing direction. The mirror edge line 15 of the reflecting mirror 8 is pushed by the arm portions 9a of the mirror pressing member 9 in the direction of arrow B, and the mirror bottom end face 16 is thereby pressed against at least two of the mirror receiving members 17a to 17f formed in the optical housing 1 and is held. The mirror bottom end face 16 is a face adjacent to the reflective surface 8a of the reflecting mirror 8. Because the reflecting mirror 8 is pushed herein from up to down, a face adjacent to the reflective surface 8a (a face other than the reflective surface) becomes the mirror bottom end face 16. However, when its layout is such that the pushing direction is, for example, from down to up, a face adjacent to the reflective surface 8a (a face other than the reflective surface) becomes a mirror top end face 8c.

FIG. 2B and FIG. 3 are enlarged views of another embodiment of the fixing structure of the reflecting mirror 8 as the main portion. In this embodiment, the opposite face 8b to the reflective surface 8a explained in FIG. 2A is received by a mirror-reflective-surface opposite-face receiving member 140 provided with the same function as that of the mirror-reflective-surface receiving member 14. That is, in the embodiment as shown in FIG. 2B, the position of the reflective surface is opposite with respect to the structure of FIG. 2A. The rest of the structure is basically the same as that of the embodiment as explained in FIG. 2A. Therefore, the same reference signs are assigned to the same components as these explained in FIG. 2A, and detailed explanation thereof is arbitrarily omitted.

As shown in FIG. 2B, the optical housing 1 includes the mirror pressing members 9 for fixing the reflecting mirror 8 to the optical housing 1, mirror-reflective-surface opposite-face receiving members 140 that come in contact with the opposite face 8b to the reflective surface 8a of the reflecting mirror 8 to receive and support the opposite face 8b, and the mirror receiving members 17a to 17f that come in contact with the mirror bottom end face 16 being a face other than the opposite face 8b of the reflecting mirror 8 in the longitudinal direction to receive and support the face. The reflecting mirror 8, the mirror pressing members 9, the mirror-reflective-surface opposite-face receiving members 140, and the mirror receiving members 17a to 17f constitute an optical device 20A. The mirror receiving members 17a to 17f are provided at intervals in the longitudinal direction of the reflecting mirror 8, and function as the mirror receiving members that support the mirror bottom end face 16 and as auxiliary mirror receiving members that become an avoidance state without coming in contact with the mirror bottom end face 16.

As shown in FIG. 2B, the reflective surface 8a of the reflecting mirror 8 is pressed against the direction of inclined surfaces 140a of the mirror-reflective-surface opposite-face receiving members 140 indicated by arrow X. At this time, the structure, in which the inclined surfaces 140a of the mirror-reflective-surface opposite-face receiving members 140 are in contact with the opposite face 8b on the opposite side to the reflective surface 8a, is different from the structure of FIG. 2A.

The mirror edge line 15 of the reflecting mirror 8 is pushed by the arm portions 9a of the mirror pressing member 9 in the direction of arrow Y, and the mirror bottom end face 16 is thereby pressed against at least two of the mirror receiving members 17a to 17f formed in the optical housing 1 and is held. The mirror bottom end face 16 is a face adjacent to the reflective surface 8a of the reflecting mirror 8. Because the reflecting mirror 8 is pushed herein from up to down, a face adjacent to the reflective surface 8a (a face other than the reflective surface) becomes the mirror bottom end face 16. However, when its layout is such that the pushing direction is, for example, from down to up, a face adjacent to the reflective surface 8a (a face other than the reflective surface) becomes the mirror top end face 8c.

As shown in FIG. 2A and FIG. 2B, the base ends 9c of the mirror pressing members 9 are fastened to planer top faces 101a and 102a of protrusions 101 and 102, which are formed in the optical housing 1, by screws 12 and are attached thereto. The protrusions 101 and 102 are arranged on both ends of the reflecting mirror 8 in the longitudinal direction as shown in FIG. 3. The mirror-reflective-surface receiving members 14 and the mirror-reflective-surface opposite-face receiving members 140 are arranged on both ends of the reflecting mirror 8 in the longitudinal direction, respectively. In this configuration, the mirror-reflective-surface receiving members 14 are formed integrally with the protrusions 101 and 102 respectively. It may also be configured that the mirror-reflective-surface receiving members 14 and the mirror-reflective-surface opposite-face receiving members 140 are formed separately from the protrusions 101 and 102 respectively to be arranged in the optical housing 1. In other words, in the case of the embodiment as shown in FIG. 2A, the mirror pressing members 9 are disposed at two locations near the both ends of the reflecting mirror 8 in the longitudinal direction, and the reflecting mirror 8 is pressed against the inclined surfaces 14a of the mirror-reflective-surface receiving members 14 and against at least two mirror receiving members of the mirror receiving members 17a to 17f. In the case of the embodiment as shown in FIG. 2B, the mirror pressing members 9 are disposed at two locations near the both ends of the reflecting mirror 8 in the longitudinal direction, and the reflecting mirror 8 is pressed against the inclined surfaces 140a of the mirror-reflective-surface opposite-face receiving members 140 and 140 and against at least two mirror receiving members of the mirror receiving members 17a to 17f.

In these embodiments, the same components are used for the two mirror pressing members 9; however, for example, different components may be used at two locations. In the embodiments, the mirror pressing member 9 is used at the two locations; however, the number of locations is not necessarily two and therefore the number of the mirror pressing members 9 to be used may be changed as needed. In the embodiments, the reflecting mirror 8 and the mirror pressing member 9 are assembled at two locations. With this structure, the reflecting mirror 8 is positioned in the optical housing 1 and is held. In the embodiments, the mirror pressing members 9 are fastened to the protrusions 101 and 102 in the optical housing 1 by screws 12 as shown in FIG. 2A and FIG. 2B respectively; however, instead of the screw fastening, it may be configured to form a groove shape and a claw shape capable of holding the reflecting mirror 8 in the optical housing 1 side, to fit the mirror pressing member 9 into the groove shape, and to fix the mirror pressing member 9 to the optical housing 1 using the elastic force of the mirror pressing member 9 itself and the claw shape. In the embodiment as shown in FIG. 2A, the mirror-reflective-surface receiving members 14 and the mirror receiving members 17a to 17f are configured to receive the reflecting mirror 8 along the inclined surfaces 14a and inclined end faces 17 respectively; however, they may be configured to receive the reflecting mirror 8 at respective points. In the embodiment as shown in FIG. 2B, the mirror-reflective-surface opposite-face receiving members 140 and the mirror receiving members 17a to 17f are configured to receive the reflecting mirror 8 along the inclined surfaces 140a and the inclined end faces 17 respectively; however, they may be configured to receive the reflecting mirror 8 at respective points.

As shown in FIG. 3, the reflecting mirror 8 is in contact with at least two locations out of the six locations of the mirror receiving members 17a to 17f provided in the optical housing 1 to be held by the optical housing 1. In the present embodiment, the mirror receiving members 17a to 17f are provided at six locations; however, the number of locations is not necessarily six, and therefore the number of the mirror receiving members 17a to 17f may be increased or decreased as required. In addition, because the mirror receiving members 17a to 17f are formed integrally with the optical housing 1, the respective positions are fixed. However, as explained later, it may be configured that the end-face receiving positions can be changed by forming the mirror receiving members 17a to 17f as different components from the optical housing 1, forming at least two of them into a shape so as to be fixed to the optical housing 1, and enabling to arbitrarily change the positions of the inclined end faces 17 of the mirror receiving members as the different components in the mirror longitudinal direction. The inclined end faces 17 are formed on the mirror receiving members 17a to 17f respectively. In the case of the structure as shown in FIG. 2A, the end faces 17 are formed so as to be inclined in the direction opposite to the inclined surfaces 14a of the mirror-reflective-surface receiving members 14. In the case of the structure as shown in FIG. 2B, the end faces 17 are formed so as to be inclined in the direction opposite to the inclined surfaces 140a and 140a of the mirror-reflective-surface opposite-face receiving members 140.

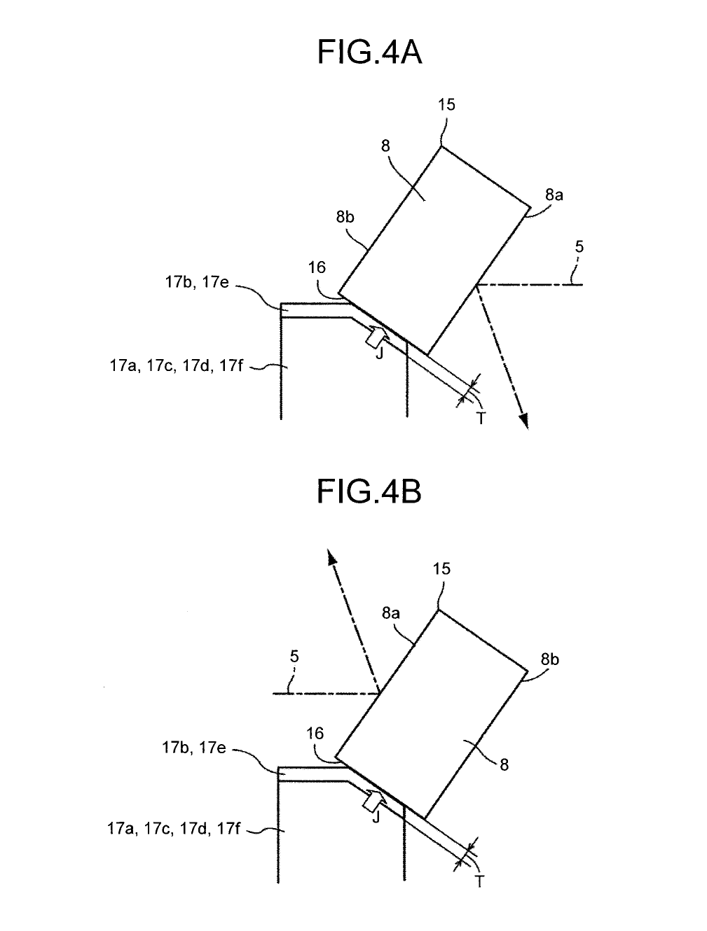

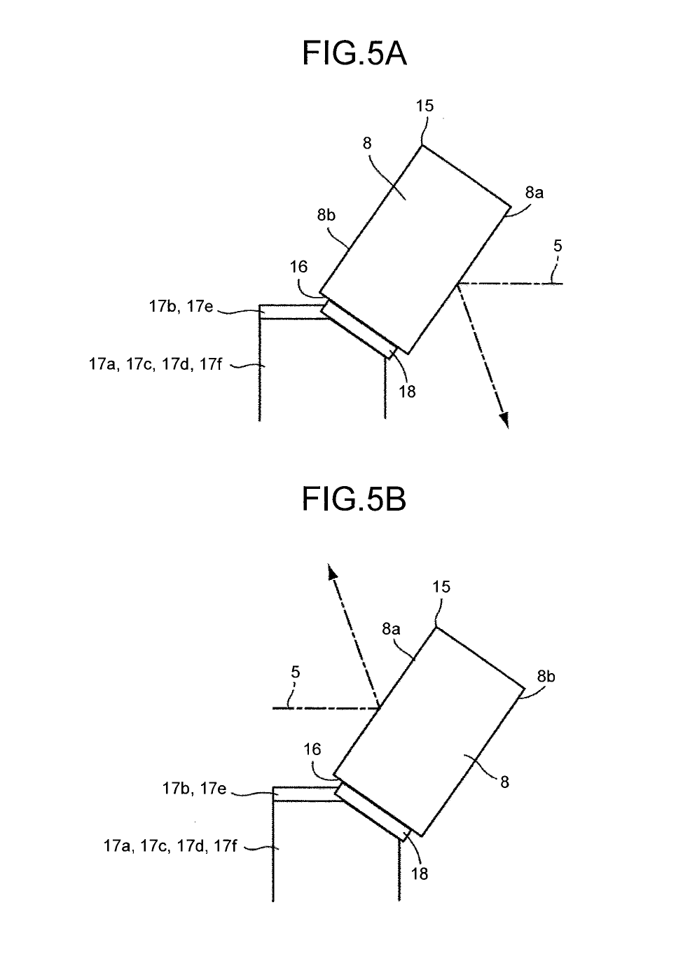

How to receive the mirror bottom end face 16 of the reflecting mirror 8 will be explained below with reference to FIGS. 4A and 4B and FIGS. 5A and 5B. FIG. 4A and FIG. 5A depict structures in which the reflective surface 8a is supported by the mirror-reflective-surface receiving members 14, and FIG. 4B and FIG. 5B depict structures in which the opposite face 8b of the reflective surface 8a is supported by the mirror-reflective-surface opposite-face receiving members 140.

To support the mirror bottom end face 16 by at least two locations out of six locations of the mirror receiving members 17a to 17f, the mirror receiving members 17b and 17e are protruded more than the other mirror receiving members 17a, 17c, 17d, and 17f in the direction of arrow J (toward the mirror bottom end face 16). In other words, the inclined end faces 17 of the mirror receiving members 17b and 17e are protruded more than the inclined end faces of the other mirror receiving members toward the mirror bottom end face 16 side. Therefore, only two points of the inclined end faces 17 and 17 of the mirror receiving members 17b and 17e come in contact with the mirror bottom end face 16. In this case, the mirror receiving members 17a, 17c, 17d, and 17f serve as auxiliary mirror receiving members.

The optical scanning device 100 is installed in the body 201, and therefore there may be a case in which the natural frequency of the reflecting mirror 8 is desired to be changed depending on the drive frequency of the drive system of the image forming apparatus 200. In this case, the receiving positions, where the reflecting mirror 8 is usually received by the inclined end faces 17 and 17 of the mirror receiving members 17b and 17e, are changed. However, at that time, by using a simple structure such that a spacer 18 thicker than a protruded amount T of the mirror receiving members 17b and 17e as shown in FIG. 4A and FIG. 4B is placed between the mirror bottom end face 16 and at least two portions of the mirror receiving members 17a, 17c, 17d, and 17f as shown in FIG. 5A and FIG. 5B, the contact positions between the mirror bottom end face 16 and the inclined end faces 17 of the mirror receiving members, i.e., the end-face receiving positions can be appropriately changed.

In the present embodiment, the inclined end faces 17 of the mirror receiving members 17b and 17e are protruded more than the inclined end faces of the mirror receiving members 17a, 17c, 17d, and 17f; however, it is preferable to arbitrarily determine the position of any mirror receiving member to be protruded depending on the drive frequency of the drive system of the image forming apparatus 200 and a mirror drive frequency of the reflecting mirror 8.

The spacer 18 is held by the elastic force of the mirror pressing members 9 (held by the two mirror receiving members and the reflecting mirror 8); however, the spacer 18 may be held by using an adhesive material to bond the spacer 18 to the two mirror receiving members or to the mirror bottom end face 16.

The receiving positions of the mirror bottom end face 16 by the two mirror receiving members are changed by placing the spacer 18 between the mirror bottom end face 16 and the two mirror receiving members; however, each protruded amount of the positions of the mirror receiving members is adjusted through machine processing, and the receiving positions of the mirror bottom end face 16 by the two mirror receiving members may thereby be changed. Alternatively, by installing a mechanical mechanism capable of changing a protruded amount at each of the positions of the mirror receiving members, the protruded amount can be adjusted, and the receiving positions of the mirror bottom end face 16 by the two mirror receiving members may thereby be changed.

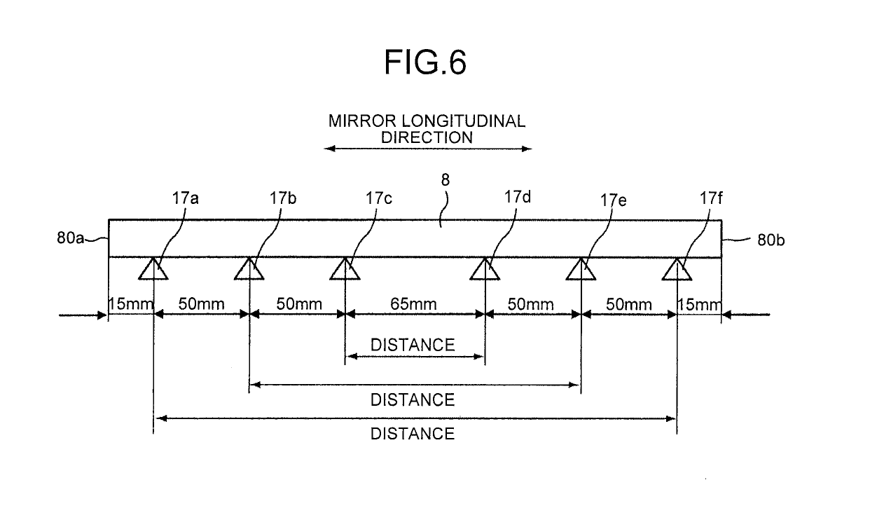

Distances of the mirror receiving members 17a to 17f in the mirror longitudinal direction will be explained below with reference to FIG. 6.

Respective centers of the mirror receiving members 17a and 17f which are both ends and are arranged on the outermost sides in the mirror longitudinal direction are located at positions 15 mm inward from end faces 80a and 80b of the reflecting mirror 8 at both ends in the mirror longitudinal direction. Respective centers of the mirror receiving members 17b and 17e are located at positions 50 mm inward of the reflecting mirror 8 from the mirror receiving members 17a and 17f, respectively. Respective centers of the mirror receiving members 17c and 17d are located at positions 50 mm inward of the reflecting mirror 8 from the mirror receiving members 17b and 17e, respectively. A center distance between the mirror receiving members 17c and 17d (distance between the receiving members) is set to 65 mm. In the present embodiment, the mirror receiving members 17a to 17f are arranged at the positions of the optical housing 1 as represented in the above manner; however, the length of the reflecting mirror 8 in the longitudinal direction and the layout of the mirror receiving members 17a to 17f are preferably changed so that the reflecting mirror 8 will obtain a desired natural frequency. In other words, the distance between the receiving positions is preferably changed.

In the present embodiment, because the structure is such that the mirror bottom end face 16 is received by the two inclined end faces of the mirror receiving members 17b and 17e, the distance between the mirror receiving members 17b and 17e becomes 165 mm. As explained in the way to receive the end face of the reflecting mirror in FIG. 4A and FIG. 4B, the receiving positions of the mirror bottom end face 16 by the mirror receiving members are arbitrarily changed, and the distance of the mirror receiving members is thereby changed.

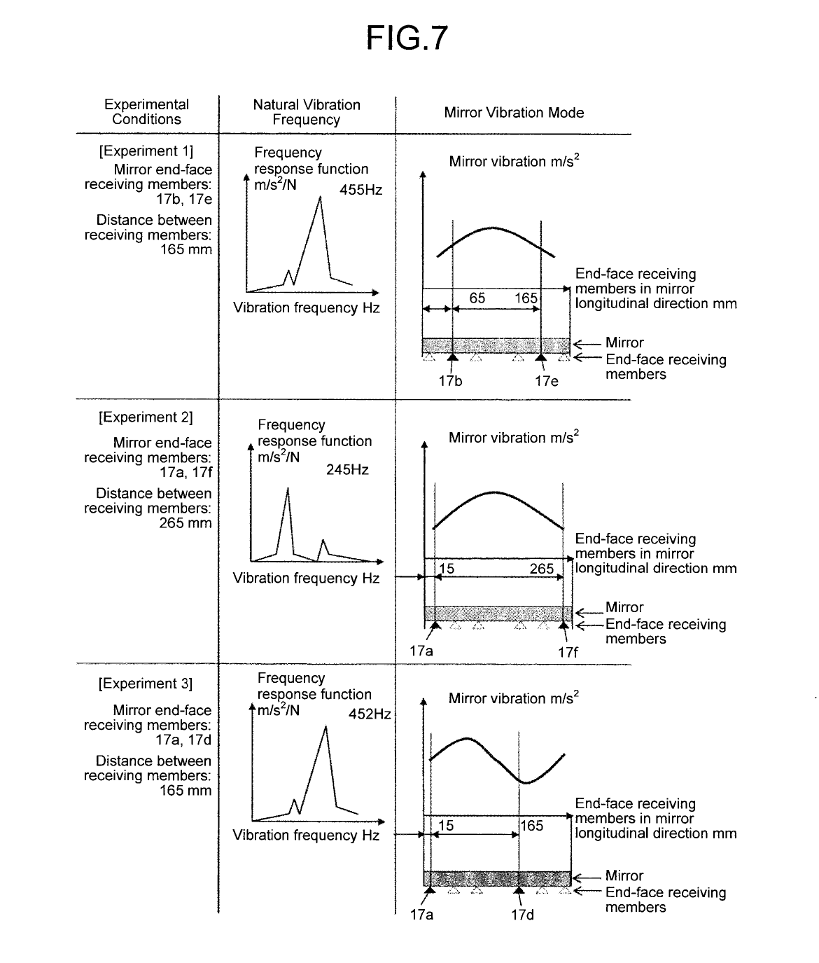

FIG. 7 is a diagram for explaining a mirror vibration frequency and a mirror vibration mode according to the receiving positions of the mirror bottom end face 16 by the mirror receiving members 17a to 17f. FIG. 7 depicts that the mirror vibration frequency and the mirror vibration mode of the reflecting mirror 8 are changed when the receiving positions of the mirror bottom end face 16 by the mirror receiving members 17a to 17f are changed. The column of Experimental Conditions describes positions of mirror receiving members and a distance between the end-face receiving members at that time. The column of Natural Vibration Frequency describes graphs each in which vibration frequency Hz is plotted on a horizontal axis and frequency response function m/s²/N is plotted on a vertical axis, and a mirror vibration frequency of the reflecting mirror 8 under each of the experimental conditions is figured out therein. The column of Mirror Vibration Mode describes graphs each in which mirror longitudinal direction and receiving positions mm of the end face are plotted on the horizontal axis and mirror vibration m/s² is plotted on the vertical axis, and at which position in the mirror longitudinal direction the reflecting mirror 8 vibrates under each of the experimental conditions is figured out therein. A line indicated in each of the graphs represents a mirror vibration mode.

The experimental conditions of Experiment 1 are such that the mirror receiving member is two points of the mirror receiving members 17b and 17e and the distance between the end-face receiving members at that time is 165 mm. Under the conditions of Experiment 1, the mirror vibration frequency of the reflecting mirror 8 becomes 455 Hz, and the vibration mode of the reflecting mirror 8 shows that an antinode of the vibration occurs at near the center of the mirror longitudinal direction.

The experimental conditions of Experiment 2 are such that the mirror receiving member is two points of the mirror receiving members 17a and 17f and the distance between the end-face receiving members at that time is 265 mm. Under the conditions of Experiment 2, the mirror vibration frequency of the reflecting mirror 8 becomes 245 Hz, and it is found that it is largely changed from the mirror vibration frequency of 455 Hz in the case of Experiment 1. The mirror vibration mode remains the same as the result of Experiment 1 and shows that an antinode of the vibration occurs at near the center of the mirror longitudinal direction.

The experimental conditions of Experiment 3 are such that the mirror receiving member is two points of the mirror receiving members 17a and 17d and the distance between the end-face receiving members at that time is 165 mm. Under the conditions of Experiment 3, the mirror vibration frequency of the reflecting mirror 8 becomes 452 Hz, which is a similar value to the mirror vibration frequency of 455 Hz as a result of Experiment 1. In addition, the mirror vibration mode represents that the position where the end face is received becomes a node of the vibration and an antinode of the vibration occurs at two locations, and shows that the mirror vibration mode is changed from that as the results of Experiments 1 and 2.

As explained above, when the reflecting mirror 8 is to be held, by changing the receiving positions of the mirror bottom end face 16 by at least two mirror receiving members, i.e., by changing the distance of the mirror receiving members 17a to 17f and the receiving positions of the mirror bottom end face 16, the mirror vibration frequency and the mirror vibration mode of the reflecting mirror 8 can be easily changed. Therefore, only by changing the holding positions (support positions) of the reflecting mirror 8, the natural frequency and the vibration mode of the reflecting mirror 8 can be easily changed, and the vibration of the reflecting mirror 8 can also be prevented without the troublesome attachment of the vibration damping material to the reflecting mirror 8 and the occurrence of cost for another member such as a plate spring.

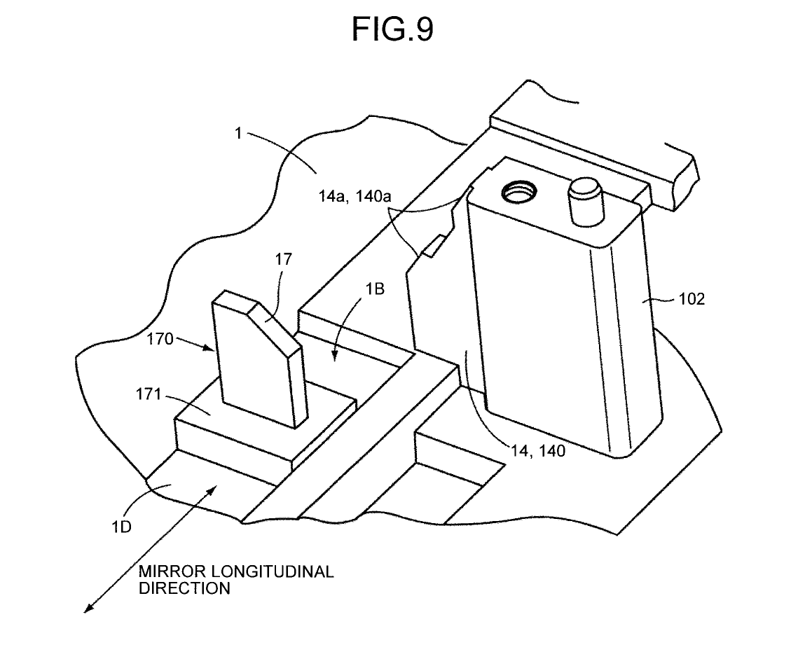

A structure in which the mirror receiving members are formed as different components from the optical housing 1 and the positions of the inclined end faces 17 can be changed to those in the mirror longitudinal direction will be explained below with reference to FIG. 9. A case in which a mirror receiving member 170 is used herein as two mirror receiving members and supports the mirror bottom end face 16 will be explained below as an example. The structures of the mirror receiving members 170 are the same as each other, and therefore only one of them is used for explanation.

As shown in FIG. 9, the mirror receiving member 170 has the inclined end face 17 along the top thereof and has a base 171 for supporting the end face 17 in the lower part thereof. A projected area of the base 171 in its planar view is formed larger than a projected area of the end face 17. Formed in the optical housing 1 is a rail portion 1B that is long and is recessed in the mirror longitudinal direction and inside of which the base 171 is disposed. The width of the rail portion 1B perpendicular to the mirror longitudinal direction is slightly wider than the width of the base 171, so that the base 171 can be moved along the mirror longitudinal direction while being placed on a contact area 1D inside of the rail portion 1B.

In this way, by forming the base 171 in the mirror receiving member 170 and forming the rail portion 1B in the optical housing 1, the position of the mirror receiving member 170 (end face 17) can be easily moved, so that the distance between the mirror receiving members 170 and 170 and the positions thereof can be changed. This enables the natural frequency of the reflecting mirror 8 to be changed. Therefore, the mirror receiving member 170 does not have to be provided in a plurality of locations as shown in FIG. 3, and there is no need to use the spacer 18 as shown in FIG. 5A and FIG. 5B.

When the mirror receiving members 17a to 17f are formed integrally with the optical housing 1 as shown in FIG. 3, the pattern of the mirror receiving positions are determined to some extent, and this results in determination of the mirror natural frequency. However, as shown in the structure of FIG. 9, by arbitrarily moving the position to any location in the mirror longitudinal direction so that the position can be changed, the position of the mirror receiving member 170 can be finely adjusted so as to obtain a desired mirror natural frequency. In the case of this structure, the mirror receiving member 170 is not fixed to the optical housing 1, and therefore there are such advantages that the mirror receiving member 170 can be easily replaced with another one when it is broken.

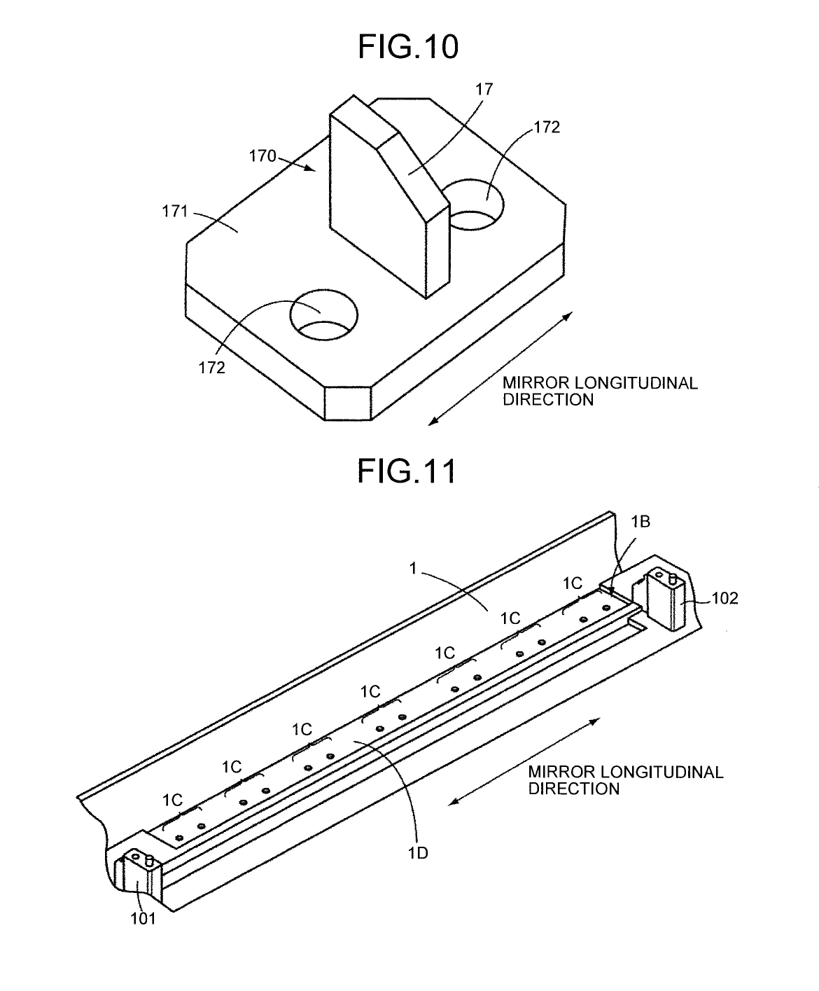

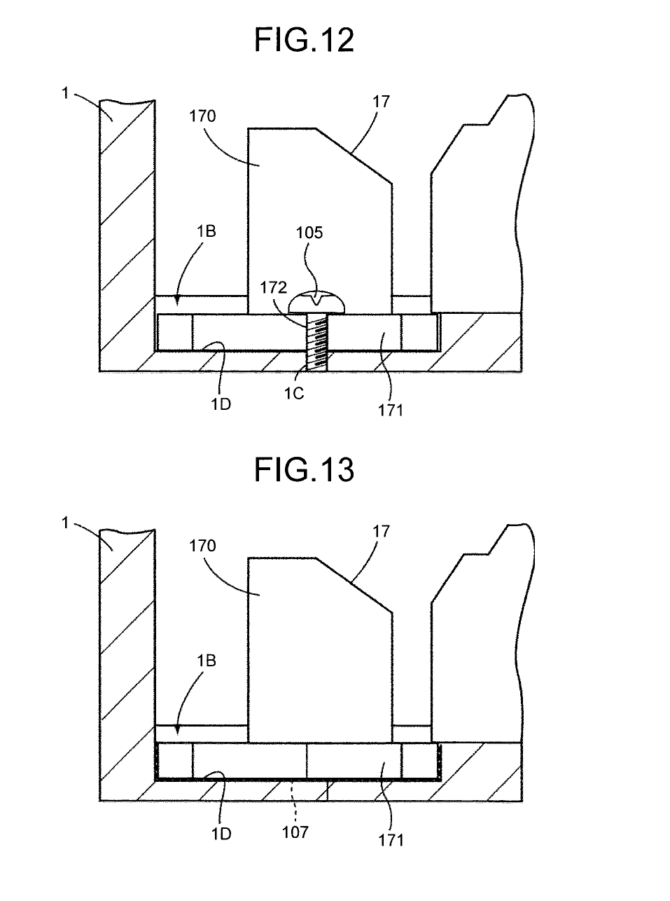

A fixing structure of the mirror receiving member to the optical housing 1 will be explained below with reference to FIG. 10, FIG. 11, and FIG. 12. As shown in FIG. 10, fixing holes 172 for fixing the mirror receiving member to the optical housing 1 are made in the base 171 of the mirror receiving member 170. In the present embodiment, the fixing holes 172 are formed one by one in the mirror longitudinal direction across the end face 17; however, the number of fixing holes 172 is preferably increased or decreased as needed.

As shown in FIG. 11, a plurality of fixing screw holes 1C for fastening the base 171 of the mirror receiving member 170 to the optical housing 1 are provided therein in the mirror longitudinal direction. Two out of the fixing screw holes 1C are set as a pair, and six pairs in total are formed on the contact area 1D of the rail portion 1B. The number of the fixing screw holes 10 is not limited to six pairs, and therefore the number can be arbitrarily increased or decreased according to the length of the reflecting mirror 8 or the like.

In this way, by forming the fixing screw holes 1C in the mirror longitudinal direction, the positions and the distance of the mirror receiving members 170 are changed so that the mirror natural frequency becomes a desired value, and the mirror receiving members 170 can thereby be fastened thereto.

The base 171 of the mirror receiving member 170 can be attached and fixed to the optical housing 1, as shown in FIG. 12, by inserting a screw 105 as a fastening member from the fixing hole 172 into the inside thereof to be screwed into the fixing screw hole 1C.

The way to fix the mirror receiving member 170 to the optical housing 1 is not limited to the screw. As shown in FIG. 13, an adhesive 107 may be applied to the base 171 of the mirror receiving member 170 and to the contact area 1D of the rail portion 1B provided in the optical housing 1, so that the mirror receiving member 170 is fixed thereto by adhesion. In this case, the fixing hole 172 does not have to be formed in the mirror receiving member 170, the fixing screw hole 1C does not have to be formed in the optical housing 1, or neither of them have to be formed. An advantage of adhesive fixing of the mirror receiving member 170 is that the mirror receiving member 170 can be disposed in any desired position in the mirror longitudinal direction. In the structure shown in FIG. 3 and in the case of screw fixing shown in FIG. 10 and FIG. 12, the reflecting mirror 8 can be received only at the previously laid-out positions in the optical housing 1. In this case, as the mirror natural frequency, also, only particularly patterned frequencies are obtained. However, in the case of adhesive fixing shown in FIG. 13, the pattern does not need to be previously formed in the optical housing 1, and the mirror receiving member 170 can be adhered to the desired position. This enables to obtain a desired mirror natural frequency.

The configuration of the image forming apparatus 200 will be explained below with reference to FIG. 8.

The image forming apparatus 200 forms monochrome images, and various components are attached to the apparatus body 201. The photoconductive photoreceptor 111 as an image carrier that is a body of a surface to be scanned is formed into a drum shape, is made to rotate clockwise at a constant speed, is uniformly charged by a charging roller 112 being a charging unit, and is optically scanned by the optical scanning device 100, so that a negative electrostatic latent image is written onto the photoreceptor 111.

The written electrostatic latent image is reversely developed by a developing device 113 to form a toner image. Pieces of transfer paper P being sheet-type recording media are stacked and stored in a cassette 118, and each of them is fed by a paper feed roller 120 and a trailing edge thereof is held by a registration roller 119. The registration roller 119 synchronizes the movement of the toner image formed on the photoreceptor 111 with the transfer paper P to feed the transfer paper P to a transfer unit.

In the transfer unit, a transfer roller 114 being a transferring unit transfers the toner image on the photoreceptor 111 onto the transfer paper P. The transfer paper P with the transferred toner image is fed into a fixing device 116 where the toner image is fixed, and is ejected onto a tray 123 by an ejection roller 122. The photoreceptor 111 after the toner image is transferred is cleaned by a cleaner 115, and residual toner and paper dust are removed therefrom.

Any one of the optical scanning devices described in the above explained specific examples is used as the optical scanning device 100, so that uneven image density (banding) occurring due to displacement of an image location of the light beam on the photoreceptor 111 can be suppressed at a low cost with such a simple configuration that the holding positions of the reflecting mirror 8 are changed. Thus, satisfactory monochrome images with less uneven image density can be formed.

The scope of application of the optical scanning device 100 according to the embodiments is not limited to the monochrome image forming apparatus. Therefore, it goes without saying that the present invention may be applied to any image forming apparatus that forms color images using developers of yellow, magenta, cyan, and black. In this case, four optical scanning devices 100 are installed in the image forming apparatus body according to the colors, and therefore the same advantageous effects as these of the present invention can be obtained. However, if the four optical scanning devices 100 are simply installed therein, the apparatus is upsized, and therefore the configuration as follows is preferable because by symmetrically arranging optical devices 20 with respect to the polygon motor 4, the optical devices 20 are stored in one optical housing 1 and by arranging a plurality of light sources 2 corresponding to the number of colors (four in this case) of the developers, the number of optical scanning devices 100 to be installed can be reduced.

The image forming apparatus includes, but not limited to, a copier, a printer, a facsimile, and a multifunction product of these devices, so that it can correspond to an electrophotographic type or an ink jet type as an image formation type.

According to the embodiments, the mirror receiving member that receives a face other than the reflective surface of the long mirror in the longitudinal direction or the opposite face to the reflective surface thereof is provided at least two locations in the mirror longitudinal direction and the distance between the mirror receiving members can be changed. Therefore, when the long mirror is to be held, the distance and the receiving positions of at least two points of the mirror receiving members are changed to thereby enable to change the mirror vibration frequency and the mirror vibration mode of the long mirror. Because of this, only by changing the long-mirror holding positions, the natural frequency and the vibration mode of the mirror can be easily changed and the vibration of the long mirror can also be prevented without the troublesome attachment of the vibration damping material to the long mirror and the occurrence of cost for another member such as a plate spring.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical device comprising:
a long mirror;
a mirror pressing member configured to fix the long mirror;
a mirror-reflective-surface receiving member configured to be in contact with a reflective surface of the long mirror; and
at least two mirror receiving members configured to be in contact with a face other than the reflective surface of the long mirror in a mirror longitudinal direction so that a distance between the mirror receiving members in the mirror longitudinal direction is variable.

2. The optical device according to claim 1, wherein each of the mirror receiving members is an end-face receiving member configured to support an end face other than the reflective surface in contact with the end face.

3. The optical device according to claim 1, wherein each of the mirror receiving members is in contact with the face adjacent to the reflective surface of the long mirror.

4. The optical device according to claim 1, wherein each of the mirror receiving members is configured to be movable along the mirror longitudinal direction.

5. The optical device according to claim 4, wherein each of the mirror receiving members is fixed to an optical housing that includes the mirror pressing member by a fastening member or by adhesion.

6. The optical device according to claim 1, wherein an auxiliary mirror receiving member that becomes an avoidance state without coming in contact with the face other than the reflective surface, the auxiliary mirror receiving member being provided in the mirror longitudinal direction.

7. The optical device according to claim 6, wherein a spacer is provided between the auxiliary mirror receiving member and the face of the long mirror and a spacer is provided between each of the mirror receiving members and the face of the long mirror.

8. The optical device according to claim 6, wherein a natural frequency and a vibration mode of the long mirror are made variable by changing a distance between receiving positions of the face other than the reflective surface on the mirror receiving members.

9. An optical scanning device comprising:
the optical device according to claim 1;
a light source;
an imaging optical element configured to condensing light emitted from the light source;
a rotary deflector configured to rotationally change the light emitted from the light source; and
a scanning optical element configured to scan the deflected light,
wherein the long mirror of the optical device is configured to guide the scanned light to an image carrier.

10. An image forming apparatus comprising the optical scanning device according to claim 9.

11. An optical device comprising:
a long mirror;
a mirror pressing member configured to fix the long mirror;
a mirror-reflective-surface opposite-face receiving member configured to be in contact with an opposite face to a reflective surface of the long mirror; and
at least two mirror receiving members configured to be in contact with a face other than the reflective surface of the long mirror in a mirror longitudinal direction so that a distance between the mirror receiving members in the mirror longitudinal direction is variable.

12. The optical device according to claim 11, wherein each of the mirror receiving members is an end-face receiving member configured to support an end face other than the reflective surface in contact with the end face.

13. The optical device according to claim 11, wherein each of the mirror receiving members is in contact with the face adjacent to the reflective surface of the long mirror.

14. The optical device according to claim 11, wherein each of the mirror receiving members is configured to be movable along the mirror longitudinal direction.

15. The optical device according to claim 14, wherein each of the mirror receiving members is fixed to an optical housing that includes the mirror pressing member by a fastening member or by adhesion.

16. The optical device according to claim 11, wherein an auxiliary mirror receiving member that becomes an avoidance state without coming in contact with the face other than the reflective surface, the auxiliary mirror receiving member being provided in the mirror longitudinal direction.

17. The optical device according to claim 16, wherein a spacer is provided between the auxiliary mirror receiving member and the face of the long mirror and a spacer is provided between each of the mirror receiving members and the face of the long mirror.

18. The optical device according to claim 16, wherein a natural frequency and a vibration mode of the long mirror are made variable by changing a distance between receiving positions of the face other than the reflective surface on the mirror receiving members.

19. An optical scanning device comprising:
the optical device according to claim 11;
a light source;
an imaging optical element configured to condensing light emitted from the light source;
a rotary deflector configured to rotationally change the light emitted from the light source; and
a scanning optical element configured to scan the deflected light,
wherein the long mirror of the optical device is configured to guide the scanned light to an image carrier.

20. An image forming apparatus comprising the optical scanning device according to claim 19.
